(19) United States
(12) Patent Application Publication
(10) Pub. No.: US 2023/0342856 A1
(43) Pub. Date: Oct. 26, 2023

(54) SELF-QUOTING SYSTEM FOR LIFE CONTINGENT AND GUARANTEED FUTURE PAYMENTS

(71) Applicant: Oscar Francis, Margate, FL (US)

(72) Inventor: Oscar Francis, Margate, FL (US)

(21) Appl. No.: 17/726,050

(22) Filed: Apr. 21, 2022

(51) Int. Cl. G06Q 40/08; G06Q 50/18

(52) U.S. Cl. CPC G06Q 40/08; G06Q 50/186

(57) ABSTRACT

A self-quoting system for life contingent payments and guaranteed future payments for charting health viability, for assisting a structured settlement provider in formulating lump sum payment offers for a recipient, in the form of real-time instant quotes, the system including a multi-tiered network, wherein a first tier of the multi-tiered network comprises a computing device having a user interface, wherein the user interface is operable to display a series of consecutive tabular forms displaying sets of field parameters pertaining to a recipient's identification, structured settlement payment information, history and lifestyle. The system further includes a second tier in communication with the first tier, the second tier including an application server configured for manipulating data responsive to the field parameters, for executing and generating an instant quote; and a third tier in communication with the second tier, configured for storing data responsive to the field parameters and the instant quote.

### BACKGROUND OF THE INVENTION

### 1. Field of the Invention

The present disclosure relates generally to a system and method for facilitating the issuance of lump sum payments to a recipient based on future payments and structured settlement transactions. More particularly, the invention relates to a self-quoting system and method for offering a lump sum payment in exchange for life contingent payments, wherein the invention relates to a system and method of charting health viability for life contingent prospects in real-time for incorporating in a fixed structure settlement transaction.

### 2. Description of the Related Art

Structured settlements provide a series of recurring payments to a recipient for a definite period of time. However, a recipient of a structured settlement may be willing to receive a discounted present lump sum payment in exchange for transferring the recipient's rights to recurring present and/or future payments.

There exists a thriving business of companies that offer structured settlements. A structured settlement company will offer to purchase a portion or all of a recipient's present and future recurring payments in exchange for providing the recipient recipient a lump sum payment, wherein the lump sum payment reflects a discounted net present value of the total sum of the recurring payments the recipient is due to receive.

For example, as a result of a structured settlement, a recipient receives a $10,000 monthly payment for a period of twenty years or two hundred and forty months. The total sum for a twenty-year period is $2,400,000. If the recipient were to elect to exchange the recurring $10,000 monthly payments for an immediate lump sum payment, the recipient may expect to receive a discounted net present value of $1,800,000, more or less.

Lump sum payments are generally applicable in two scenarios. The first scenario entails guaranteed recurring payments whereas the second scenario entails life-contingent recurring payments. In the case of guaranteed recurring payments, the monthly payments are not contingent on the life expectancy of the recipient. For example, if a recipient were to pass on before the termination of the payment period, the remaining payments would be transferred to the recipients' heirs or assigns.

In contrast, life contingent recurring payments cease if the recipient passes on. Accordingly, a funding company is at risk of losing its investment in the event of a premature death. Thus, many structured settlement companies avoid or refuse to become involved or participate in transactions relating to life contingent settlements.

It would seem that a possible solution for bridging that gap and hedging a bet for a structured settlement company is to obtain life insurance for a prospective client/recipient wishing to exchange life contingent payments for lump sum payments. This however is not a viable option in many instances, since structured settlements are often the result of a personal injury which renders the client/recipient virtually uninsurable. Discount rates for life contingent payments without life insurance are heavily predicated on the client's life expectancy and mortality rating. Longer the life expectancy and lower the mortality rating, lower the discount rate which translates to a higher lumpsum amount for the client. So the rates like any other financial asset are predicated supply and demand and interest environment.

The prior art teaches a system and method for online settling of transactions whereby the system includes a server arrangement having a rules-based engine including rules established on behalf of a party to the transaction, such as a creditor. The rules-based engine is configured to process data and present a transaction settlement offer set comprising a plurality of selectable offers to the user based on at least one decision made by the rules based engine. The server arrangement is further configured to receive a lump sum payment proposal from the user and to use the rules-based engine to process information comprising the lump sum payment proposal from the user and to use the rules-based engine to process information comprising the lump sum payment proposal and present a second transaction settlement offer set to the user based at least in part on the lump sum payment proposal from the user. U.S. Pat. No. 9,733,278B2 (to Imrey et al.).

U.S. Publ. No. 2018/0247372 A1 (to Gerber et al.) teaches a method and system for structured settlement auctions and trading and exchange. In particular Gerber et al. teaches a method and system that provides an automated and trading exchange for structured settlements. The automated auction and trading system automatically determines and processes structured settlement and cash flow sales between buyers and sellers. The system may process the entire transaction automatically and electronically, including document processing and receipt and transmission of funds.

U.S. Pat. No. 10,984,478 (to Smith) discloses a system and method that allows a user to interactively and iteratively create, manage, customize and price optimized annuity product composition.

The prior art also discusses a method for automatically extracting data and generating insurance quotes includes preparing insurance profiles having risk information for clients seeking insurance coverage, storing the insurance profiles in an electronic database at one or more agency locations, and extracting one or more of the stored insurance profiles from the electronic database. Information from the extracted insurance profiles is translated into a format recognizable by one or more underwriters for risk assessment. The translated information is electronically transmitted to one or more underwriters so that the underwriters can analyze the risk information for determining whether offers of insurance should be made to the clients seeking insurance coverage. The offers of insurance are electronically transmitted to the one or more agency locations in a proposal format presentable to the clients seeking insurance. The entire process requires that data be entered only once, thereby eliminating the time-consuming and error-enabling multiple steps involved in data re-entry at various levels. U.S. Pat. Pub. No. 2002/0194033 A1 (to Huff).

U.S. Pat. No. 7,734,524 B2 (to Tyson) teaches a customized financial instrument providing a stream of payments, defined by at least a plurality of parameters received from a purchaser, includes an agreement by an issuer to make a stream of payments. The stream of payments is defined by the plurality of parameters received from the purchaser. The plurality of parameters includes a first date defining the date for the first payment; at least one of a second date defining the date for the last payment, number of payments, and a duration for the stream of payments; and information defining payment amounts for each of the payments. The customized financial instrument is associated with an identification code, the identification code being issued by a third-party organization and the identification code being unique to the customized financial instrument defined by at least a plurality of parameters received from a purchaser.

One of the primary disadvantages of method and systems for structured settlements known in the art, is that they do not have a reliable method of adequately assessing risk. Structured settlement companies fail to adequately address a situation wherein a recipient may be largely uninsurable because the structured settlement received by the recipient is due to a serious personal injury and therefore it is difficult if not impossible for a structured settlement company to secure an insurance policy on a recipient that wishes to exchange a life contingent recurring payment settlement for a lump sum payment.

In the context of structured settlements, it is desirable to have a system and method that mitigates the risk of life contingent recurring payments to a structured settlement company, by accurately charting the health viability of a life contingent recipient in real time in order to ensure that only qualified recipients with an improved likelihood of securing insurance are considered. It is appreciated that throughout the application, the term beneficiary may be used interchangeably with the term recipient if applicable.

### SUMMARY OF THE INVENTION

In accordance with the present invention, a system and method is disclosed that provides structured settlement companies with a method to more accurately gauge, assess and manage the risk and costs to a company offering a recipient a present lump sum payment in exchange for a structured settlement in instances where the recurring payments of the structured settlement are contingent on the recipient's life.

The invention provides a system and method of charting health viability for life contingent prospects in order to maximize the present lump sum payment to the recipient while simultaneously minimizing the risk of a recipient's premature death, to the structured settlement company.

In one embodiment, the life risk analysis management method and system of the present invention teaches a method and system of determining a discounted minimum and maximum range for a present lump sum payment to a recipient.

In one embodiment the invention invites a user to respond to inquiries presented in three forms in three separate sections within the system beginning with a first form relating to introductory identification information pertaining to the recipient; a second form relating to payment information pertaining the recipient's structured settlement; and a third form relating to basic information pertaining to the recipient's health.

In one aspect of the invention, the user is provided with an option of completing the entire grid comprising all three forms or of skipping one or more forms. It is appreciated that the more information and data provided relating to the recipient, the more the instant quote is likely to be reliable and accurate. If the user elects to skip forward and directly ask the system to generate an instant quote, the system will auto fill favorable data points conducive to generating an optimal quote for the recipient. In this circumstance, the instant quote generated for the recipient will be the highest possible amount offered to the recipient. It is understood that the term “quote” as referred throughout this application refers to an “instant quote” and that the terms “quote” and “instant quote” are referred to interchangeably. It should also be appreciated that the term “instant” as used throughout this application is defined to represent a period of time of less than ten (10) seconds.

An aspect of the invention provides the user with the option of skipping one or more field entries within one or more of the three forms. The user of the system may optionally skip the third form and ask the system to generate an instant quote. In a preferred embodiment of the invention, the three forms may only be accessed one a time and in consecutive order, from the first form to the second form, followed by the third form respectively.

In another embodiment the method and system of the invention provides for a user with the option to add additional recipient information that may be required by a structured settlement company to provide the recipient with an instant quote that is configured to be tailored and specific to the recipient for the purpose of providing a more accurate lump sum payment quote. In this embodiment, the recipient provides data directed to the recipient's lifestyle and physical profile, a financial risk history profile and a medical profile.

For example, inquiries directed to a recipient's lifestyle or physical profile may include inquiries such as: “are you physically active?”, “does your diet consist of healthy portions of fruits and vegetables?”, “how may portions of fruits or vegetable do you intake on a daily basis?”, “do you have a history of physical disabilities?”, “how much alcohol do you consume on a daily basis?” or “do you have a history of drug abuse?”. Inquiries directed to a recipient's financial risk profile may include: “have you declared bankruptcy in the past five (5) years?” or “what is your credit rating?”. Additionally, inquiries directed to a recipient's medical profile may include: “do you have a history of HIV or AIDS?”, “do you have any major medical history?”, “do you currently have or have you had a history of asthma; diabetes type 1 or type 2; liver issues; kidney issues; sleep apnea; cancer; depression; bipolar disorder; neurological disorder; psychiatric disorder; anxiety; or heart issues including any heart issue requiring an angioplasty?”.

An aspect of the life risk analysis management method and system of the present invention discloses a system to chart the health and viability of a life contingent recipient in real time for the purpose of offering the recipient a lump sum payment in exchange for the recipient's structured settlement.

An object of the invention is to reduce the risk to a structured settlement company of paying a present lump sum payment to a recipient, where the recurring payments are contingent on the life expectancy of the recipient.

Another object of the invention is to overcome the negative perception that often clouds the structured settlement sector due to recipients with poor life expectancies receiving very low offers of lump sum payments in exchange for their life contingent payments.

An advantage of the system and method of the present invention is that it generates instant quotes to a prospective client/recipient and sales associates.

Yet another advantage of the system and method of the present invention is that it provides a prospective client/recipient with the option of receiving a generalized instant quote after providing basic preliminary information without requiring more detailed information necessary to generate a detailed quote.

Another advantage of the system and method of the present invention is that it ensures that only qualified applicants are forwarded to agents, thereby maximizing the likelihood that an applicant will be approved for a life insurance policy and an offer of a lump sum payment in exchange for structured settlement payments.

These and other aspects and advantages of the present disclosure will become apparent from the following detailed description of preferred embodiments of the invention considered in conjunction with the accompanying drawings, in which like drawings represent like components. It is to be understood, however, that the drawings are designed solely for purposes of illustration and not as a definition of the limits of the disclosure, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE INVENTION

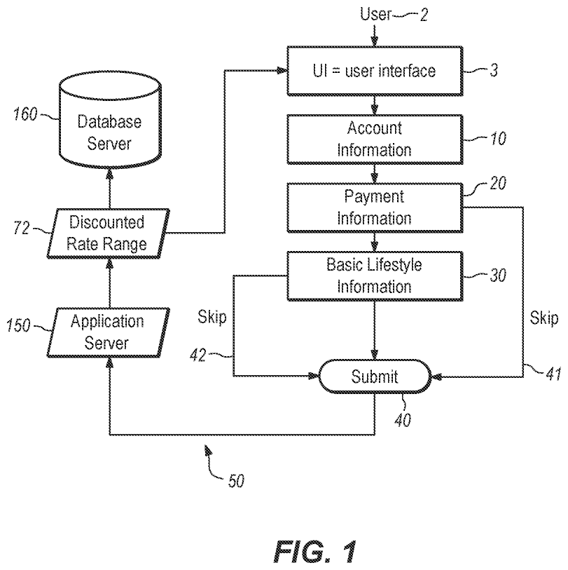

FIG. 1 is a flow chart of the system and method of the present invention illustrating the process of using an interface to generate a quote.

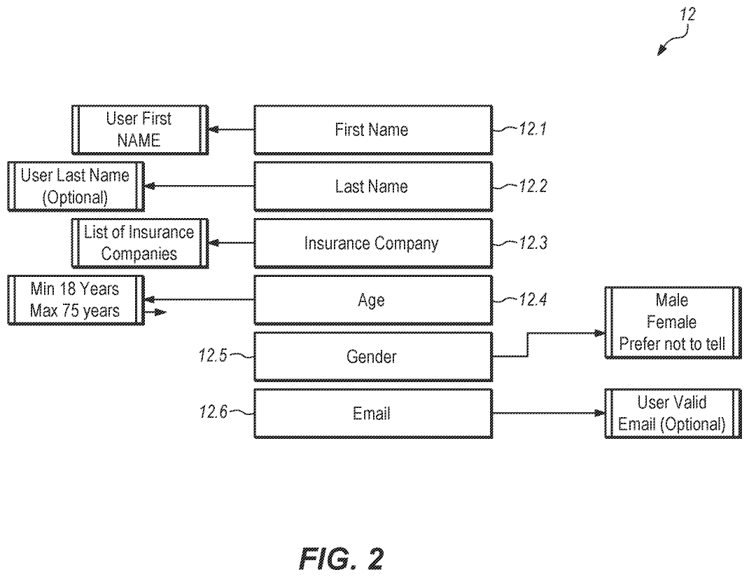

FIG. 2 is a conceptual block diagram illustrating an embodiment of a first step in the process relating to the first tabular form displayed in the first tier of the networking system of the present invention.

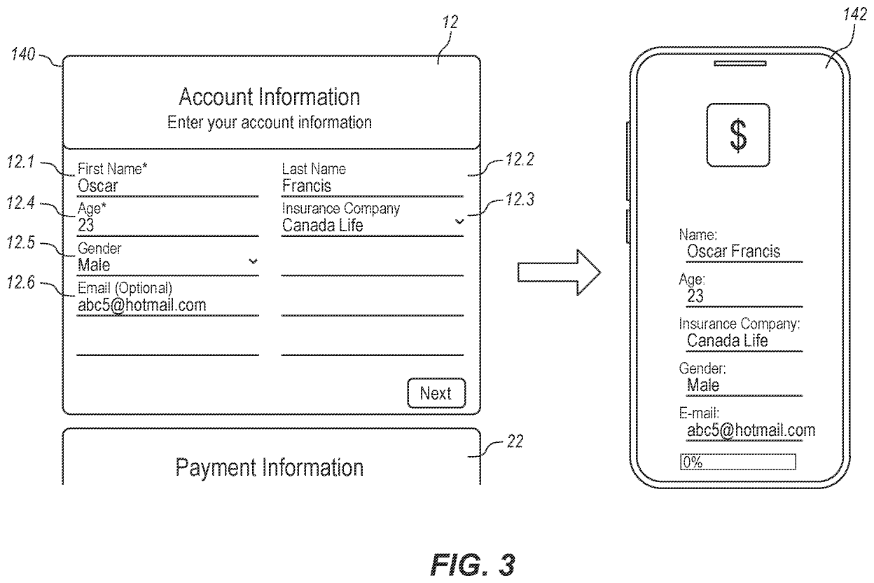

FIG. 3 is an illustration of an embodiment of a display of the first tabular form as it would appear on a computing device when using the system and method of the present invention.

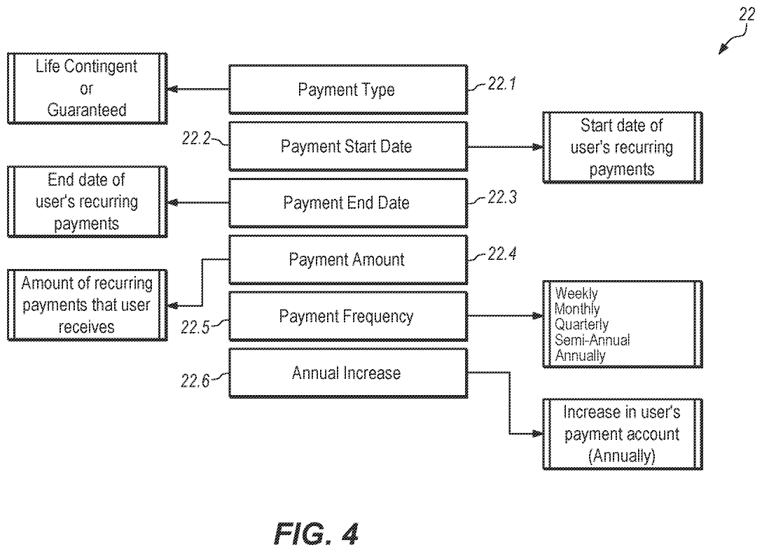

FIG. 4 is a conceptual block diagram illustrating an embodiment of a second step in the process relating to the second tabular form displayed in the first tier of the networking system of the present invention.

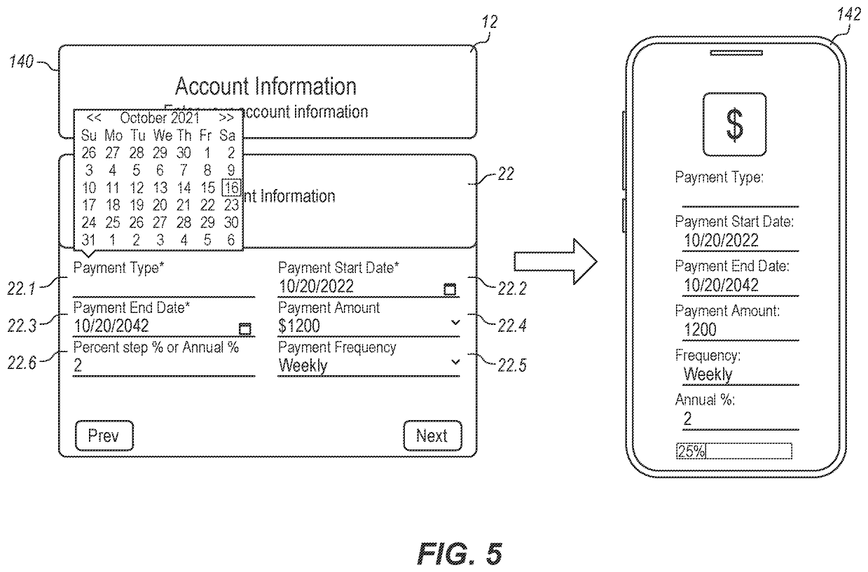

FIG. 5 is an illustration of an embodiment of a display of the second tabular form as it would appear on a computing device when using the system and method of the present invention.

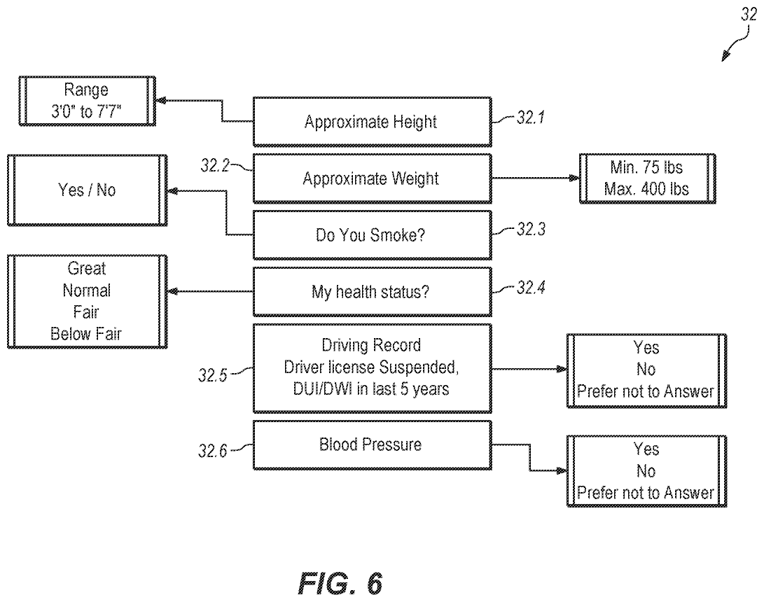

FIG. 6 is a conceptual block diagram illustrating an embodiment a third step in the process relating to the third tabular form displayed in the first tier of the networking system of the present invention.

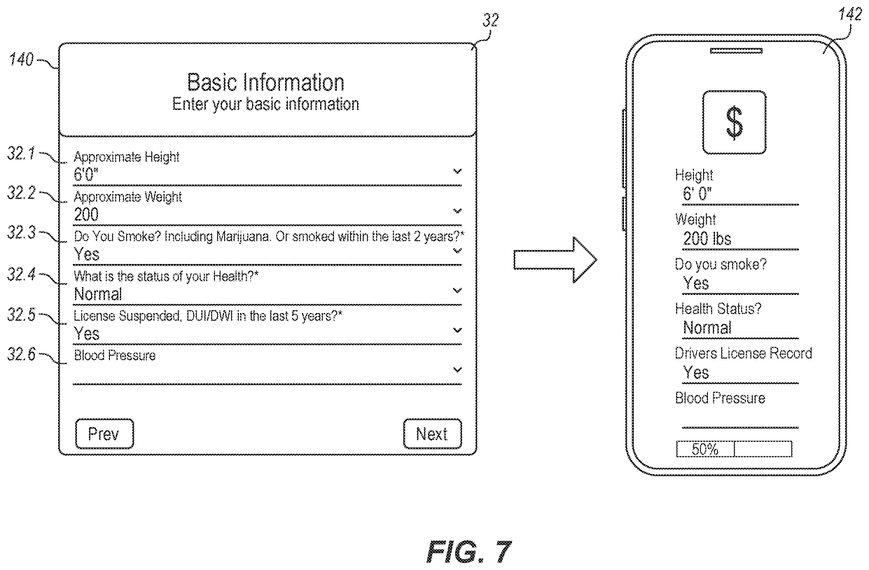

FIG. 7 is an illustration of an embodiment a display of the third tabular form as it would appear on a computing device when using the system and method of the present invention.

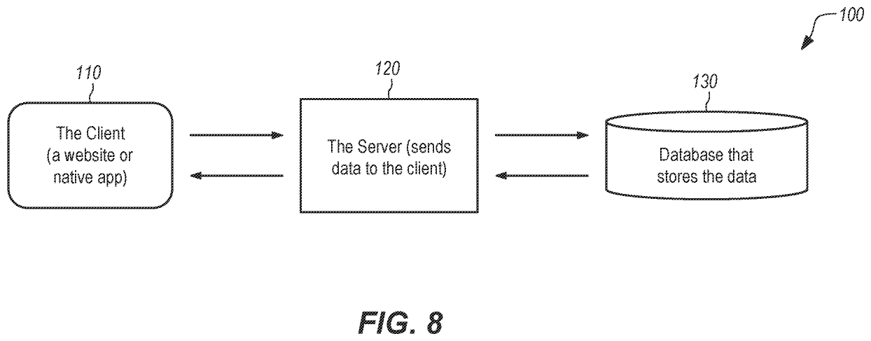

FIG. 8 is a conceptual block diagram illustrating the interconnection of the first, second and third tiers of the networking system of the present invention

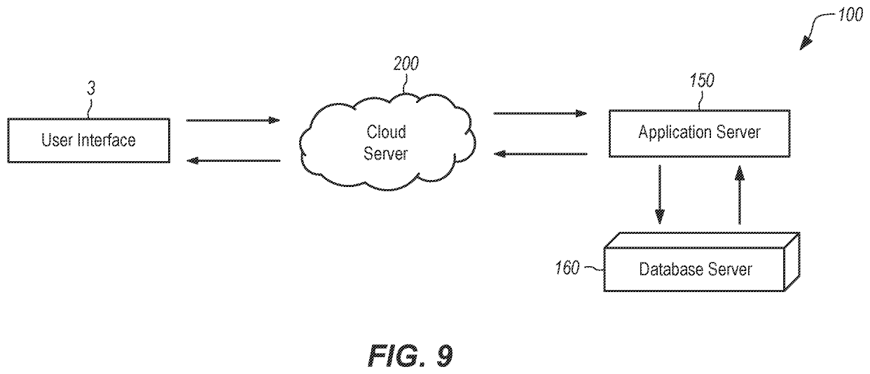

FIG. 9 illustrates the cloud base hosting aspect of the present invention in connection with a user interface and the second tier, or backend server in relation to the third tier, or application server of the present invention.

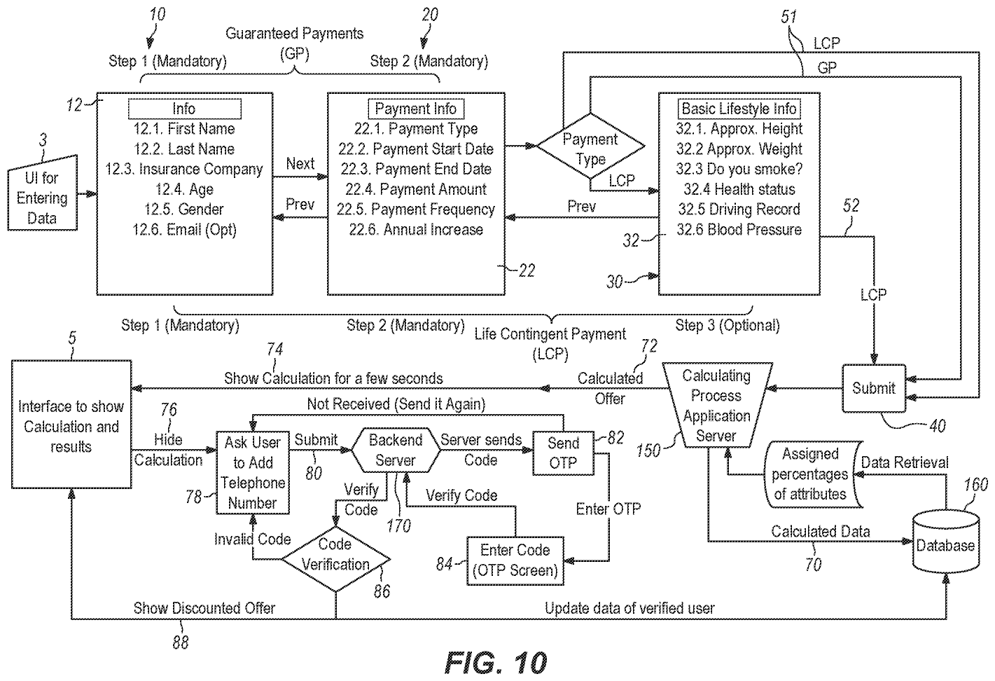

FIG. 10 is a conceptual block diagram illustrating an embodiment of the process of the system and method of the present invention.

### DETAILED DESCRIPTION OF THE PREFERRED EMBODIMENTS

The terms customer or client may be used throughout to refer to a recipient of a structured settlement plan. The term user is used throughout to refer to the user of the invention. It is appreciated that a user may include by way of example and not limitation, a client, a recipient, a sales associate or agent.

Referring now to FIGS. 1-10, there are shown illustrations of a process for a life risk analysis system and method 1 for generating life contingent payments for a potential client and/or recipient. The system 1 includes a multi-tiered network 100 including a first tier 110, a second tier 120 and a third tier 130. The first tier 110 includes an Internet browser on a computing device 140 such as for example, a desktop or smart phone. The second tier 120 includes an application server 150 for processing data and generating quotes 170 and the third tier 130 includes a database server 160 for storing data and quotes.

In particular, FIG. 1 is a flow chart of the system 1 of the present invention illustrating an overview of the process 1. As shown a user 2 employs a user interface 3 to generate a quote/discounted range 72. The user 2 completes a first step 10 relating to a recipient's account information, a second step 20 relating to a recipient's payment information, and a third step 30 relating to a recipient's basic information, wherein the user 2 provides the recipient's account information in the first step 10, the recipient's payment information in the second step 20, and the recipient's basic lifestyle information in the third step 30.

In a fourth step 40 the user 2 submits data compiled from the first step 10, the second step 20 and the third step 30, such that the account information of the first step 10, payment information of the second step 20, and basic lifestyle information of the third step 30 is submitted for processing. In a fifth step 50 data from the first step 10, second step 20 and third step 30, and data submitted in the fourth step 40 is directed to the application server 150 of the second tier 120 (shown in FIGS. 8 and 9) for calculating and generating a discounted rate range. Data generated from the first step 10, second step 20 and third step 30, and the discounted range quote 72 generated by means of the application server 150 of the second tier 120 is stored in the database server 160 of the third tier 130 (shown in FIGS. 8 and 9).

The user 2 may proceed to a first alternative fourth step 41 of submitting data directly from the second step 20, thereby effectively bypassing the third step 30. Data submitted in the first alternative fourth step 41 is directed to the application server 150 of the second tier 120 (shown in FIGS. 8 and 9) of the multi-tiered network 100 (shown in FIGS. 8 and 9) for calculating/generating a discounted rate range 72. Data generated from the first step 10 and the discounted data range 72 generated by means of pursuing the first alternative fourth step is stored in the database server 160 of the third tier 130 (shown in FIGS. 8 and 9) of the multi-tiered network 100 (shown in FIGS. 8 and 9).

In yet another embodiment, the user 2 may proceed to a second alternative fourth step 42 of submitting data from the first step 10, the second step 20 and the third step 30. Data submitted in the second alternative fourth step 42 is directed to the application server 150 of the second tier 120 of the multi-tiered network 100 (shown in FIGS. 8 and 9) for calculating/generating a discounted rate range 72. Data generated from the first step 10 and the discounted data range 72 generated by means of pursuing the second alternative fourth step 42 is stored in the database server 160 of the third tier 130 of the multi-tiered network 100 (shown in FIGS. 8 and 9).

In FIG. 2 there is shown a conceptual block diagram illustrating an embodiment of the first step 10 in the process 1 relating to a first tabular form 12 of the first step 10 displayed in the first tier 110 of the multi-tiered network 100 (shown in FIG. 11) of the present invention, wherein the first tabular form 12 includes a first plurality of fields 12.1-12.6. Thus, there is shown the first plurality of fields 12.1-12.6 within the first step 10. In particular the user 2 (shown in FIGS. 1, 10) is prompted to enter the recipient's first name in a first field 12.1, the recipient's second name in a second field 12.2, an insurance company name in a third field 12.3, wherein the insurance company name may be selected from of list of potential providers, and wherein the insurance company name further provides an-option for the user 2 (shown in FIGS. 1, 10) to select “other” as an option for the insurance company name.

The first tabular form 12 of the first step 10, additionally include fields for the recipient's age 12.4, the recipient's gender 12.5. In a preferred embodiment, optional fields for the gender 12.5 include by way of example, male female or prefer not to tell. Field 12.6 includes an optional field for an email address 12.6. In an embodiment, fields 12.1, 12.2, 12.3, 12.4, 12.5 and 12.6 may not be skipped by the user and data responsive to fields 12.1, 12.2, 12.3, 12.4, 12.5 and 12.6 in the first tabular form 12 must be provided by the user.

FIG. 3 is an illustration of an embodiment of a display of the first tabular form 12 of the first step 10, as it would appear on a computing device 140 when using the system and method 1 of the present invention. As shown, the user 2 (shown in FIGS. 1, 10) completes the first plurality of fields 12.1-12.6 of the first step 10 (as shown in FIG. 2) of first tabular form 12. The user 2 (shown in FIG. 1) enters the first name in field 12.1, the last name in field 12.2, the insurance company name in field 12.3, the age in field 12.4, the gender in field 12.5 and the e-mail address in field 12.6. The recipient's data responsive to the first plurality of fields 12.1-12.6 is displayed to the user 2 (shown in FIGS. 1, 10)) on a screen 142 of the computing device 140.

FIG. 4 is a conceptual block diagram illustrating an embodiment of the second step 20 in the process relating to a second tabular form 22 of the second step 20 of the system and method 1 of the present invention displayed in the first tier 110 (shown in FIG. 11) of the multi-tiered networking system 100 (shown in FIG. 11) of the present invention. A second plurality of fields 22.1-22.6 includes a field for a payment type 22.1, a field for a payment start date 22.2, a field for a payment end date 22.3, a field for payment amount 22.4, a field for payment frequency 22.5 and a field for an annual percent increase 22.6. An annual percent increase 22.6 offsets inflation. In an embodiment, fields 22.1, 22.2, 22.3, 22.4, 22.5 and 22.6 may not be skipped by the user and data responsive to fields 22.1, 22.2, 22.3, 22.4, 22.5 and 22.6 in the second tabular form 22 must be provided by the user.

In one embodiment, the annual percent increase 22.6 is a figure determined to offset the cost of inflation. For example, a structured settlement may commence at $1000 a month with an annual three percent increase. The payment type 22.1 is optionally a life contingent payment or a guaranteed payment. The field for the payment start date 22.2 represents the date when recurring payments made to a recipient begin. It is understood that the user 2 (shown in FIGS. 1, 10) may also be the recipient. The field for the payment end date 22.3 is the date when recurring payments made to a recipient end. The field for the payment amount 22.4 is the amount of each recurring payment received by the recipient. In one embodiment, the field for payment frequency 22.5 may be categorized to include a field for weekly payments, monthly payments, quarterly payments, semi-annual payments or annual payments.

FIG. 5 is an illustration of an embodiment of the second tabular form 22 as it would appear on the display 142 of the computing device 140 (shown in FIG. 6) when using the system and method 1 of the present invention. The user 2 (shown in FIG. 1) completes the second plurality of fields 22.1-22.6 of the second step 20 of the second tabular form 22 (as shown in FIG. 4), the user 2 (shown in FIG. 1) enters the payment type in the first field 22.1 of the second tabular form 2, the payment start date in a second field 22.2 of the second tabular form 22, the payment end date in the third field 22.3 of the second tabular form 22, the payment amount in the fourth field 22.4 of the second tabular form 22, the payment frequency in the fifth field 22.5 of the second tabular form 22 and the annual increase in the sixth field 22.6 of the second tabular form 22 as a percentage rate. Data responsive to the second plurality of fields 22.1-22.6 is displayed on the screen 142 of the computing device 140.

FIG. 6 is a conceptual block diagram illustrating an embodiment of a third plurality of fields 32.1-32.6 relating to a third tabular form 32 of the third step 30 of the system and method 1 displayed in the first tier 110 (shown in FIG. 11) of the multi-tiered networking system 100 (shown in FIG. 11) of the present invention. The third plurality of fields 32.1-32.6 includes a field directed to an inquiry into the recipient's height 32.1, wherein in a preferred embodiment, the field for the height 12.8 is within a range having a minimum height and a maximum height. In a preferred embodiment, the minimum height is 3 feet and the maximum height is 7 feet and 7 inches. The third plurality of fields 32.1-32.6 further includes a field directed to an inquiry into the recipient's weight 32.2, wherein in a preferred embodiment, the field for weight 32.2 is required to be within a range having a minimum weight and a maximum weight.

In a preferred embodiment, the minimum weight is 75 pounds and the maximum weight is 400 pounds. The third plurality of fields 32.1-32.6 further includes a field directed to an inquiry into whether the recipient smokes 32.3, wherein an acceptable response includes a field for yes or no. The third plurality of fields 32.1-32.6 further includes a field directed to an inquiry into a health profile of the recipient 32.4. The third plurality of fields 32.1-32.6 further includes a field directed to an inquiry into a driver's record, including driver license suspension in the last five years 32.5, wherein acceptable responses include fields for yes, no or prefer not to answer. The third plurality of fields 32.1-32.6 further includes a field directed to an inquiry into the recipient's blood pressure 32.6, wherein acceptable responses include fields for normal, medicated, high, not sure or prefer not to answer. In an embodiment, fields 32.1, 32.2, 32.3, 32.4, 32.5 and 32.6 may not be skipped by the user and data responsive to fields 32.1, 32.2, 32.3, 32.4, 32.5 and 32.6 in the third tabular form 32 must be provided by the user.

FIG. 7 is an illustration of an embodiment of a display of the third tabular form 32 as it would appear on the computing device 140 when using the system and method 1 of the present invention. As shown, the user 2 (shown in FIGS. 1, 10) completes the third plurality of fields 32.1-32.6 of the third step 30 of the third tabular form 32 (shown in FIG. 6). The user 2 enters a response to inquiries regarding the recipient in fields directed to the recipient's height 32.1, weight 32.2, smoking habits 32.3, the recipient's health profile 32.4, driving record, including record of driver license suspension in the last five years 32.5 and the recipient's blood pressure 32.6. Data responsive to the third plurality of fields 32.1-32.6 is displayed to the user 2 (shown in FIG. 1) on the computing device 140.

FIG. 10 is a conceptual block diagram illustrating an embodiment of the process of the system and method 1 of the present invention. In order for a user 2 to calculate an offer 170, data pertaining to a recipient is inputted into the system 1. The first step 10, is to input data in the first plurality of fields 12.1-12.6 of the first tabular form 12. The second step 20 allows the user 2 to input data in the second plurality of fields 22.1-22.6 of the second tabular form 22. The third step 30 allows the user 2 to input data in the third plurality of fields 32.1-32.6 of the third tabular form 32. Optionally, the user 2 may elect to skip the third step 30. The user 2 is invited to accept terms and conditions 80. If terms and conditions are not accepted, the system 1 will process an error 82. Once the user 2 submits 40 data the system 1 may prompt the user 2 to enter the phone number 78. The user 2 may elect to go back to a prior step, in which event a pop will appear to advise the user 2 that “[t]he information entered will be erased and the process will be restarted.” If terms and conditions 80 are accepted by the user 2 data entered from the first form 10, second form 20 and third form 30, is submitted 84 for processing to the application server 150 of the second tier 120 of the multi-tiered networking system 100 to calculate the offer or discounted rate range 72. The next step in the process is to store the recipient's data in the database server 160 of the third tier 130 of the multi-tiered networking system 100. An operation decision 86 is made to offer a discounted range 72 The user 2 is invited to enter a phone number 78 and enter a verification code 88 in order to view the offer or discounted rate range 72.

FIG. 11 is a conceptual block diagram illustrating the interconnection of the first tier 110, a second tier 120 and a third tier 130 of the multi-tiered networking system 100. There is shown communication between the first tier 110 and the second tier 120, whereby the first tier 110 relays data to the second tier 120 which includes the backend or application server 150 and wherein the first tier 110 receives data from the second tier 120. The first tier 110 is a client tier and may include a web browser on the computing device 140. The computing device 140 may be a desktop, laptop, smartphone or the like. The second tier 120 is preferably a business logic tier and includes the application server 150 for receiving and processing data transmitted from the first tier 110. The second tier 120 transmits data to the third tier 130. The third tier 130 is preferably a database tier including the database server 160 for storing data received from the first tier 110 and the second tier 120. The third tier 130 may also transmit stored data to the second tier 120, where it can be further transmitted to the first tier 110.

FIG. 12 illustrates the cloud base hosting aspect of the system 1 whereby the first tier 110 includes and/or is a client server and includes the user interface 3, such as a browser on the computing device 140 (shown in FIGS. 3,5,7,9) in communication with the second tier 120 via a cloud-based server 200. The second tier 120 includes and/or is a backend or application server 150 and transmits data to and receives data from the third tier 130, wherein the third tier 130 includes and/or is a database server 160.

Thus, while there has been shown and described, fundamental novel features of the disclosure as applied to various specific embodiments thereof, it will be understood that various omissions and substitutions and changes in the form and details of the apparatus illustrated, and in their operation, may be made by those skilled in the art without departing from the spirit of the disclosure. For example, it is expressly intended that all combinations of those elements which perform substantially the same function, in substantially the same way, to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore to be limited only as indicated by the scope of the claims appended hereto.

I claim:

1. A self-quoting system for life contingent payments and guaranteed future payments, for assisting a structured settlement provider in formulating lump sum payment offers for a recipient, the system comprising:
a multi-tiered network, wherein a first tier of the multi-tiered network comprises a computing device having a user interface, wherein the user interface is operable to display a first tabular form comprising a first set of field parameters, for receiving and displaying a first set of data responsive to the first set of field parameters;
a second tier of the multi-tiered network in communication with the first tier, wherein the second tier comprises an application server for receiving the first set of data responsive to the first set of field parameters from the first tier and wherein the application server is configured for manipulating the first set of data responsive to the first set of field parameters and for executing and generating a first set of calculations thereon;
a third tier of the multi-tiered network in communication with the second tier, wherein the third tier includes a database server configured for storing data within the multi-tiered network, whereby data stored in the database server includes the first set of data responsive to the first set of field parameters and the first set of calculations executed and generated by the second tier.

2. The system of claim 1, wherein in response to a command by the user, the user interface is operable to display a second tabular form comprising a second set of field parameters, for receiving and displaying a second set of data responsive to the second set of field parameters, and wherein the second tabular form is displayed consecutively and subsequently to the first tabular form;
the system of claim 2, wherein the second tier is configured to receive the second set of data responsive to the second set of field parameters from the first tier and wherein the application server is configured for manipulating the second set of data responsive to the second set of field parameters and for executing and generating a second set of calculations thereon; and
wherein data stored in the database server includes the second set of data responsive to the second set of field parameters and the second set of calculations executed and generated by the second tier.

3. The system of claim 2, wherein in response to a command by the user, the user interface is operable to display a third tabular form comprising a third set of field parameters, for receiving and displaying a third set of data responsive to the third set of field parameters, and wherein the third tabular form is displayed consecutively and subsequently to the second tabular form;
the second tier is configured to receive the third set of data responsive to the third set of field parameters from the first tier and wherein the application server is configured for manipulating the third set of data responsive to the third set of field parameters and for executing and generating a third set of calculations thereon; and
wherein data stored in the database server includes the third set of data responsive to the third set of field parameters and the third set of calculations executed and generated by the second tier.

4. The system of claim 1, wherein the application server of the second tier of the multi-tiered network generates a lump sum payment quote that is instantaneously relayed to the first tier of the multi-tiered network for transmission to the user, and wherein the lump sum payment quote is simultaneously transmitted instantaneously to the database server of the third tier of the multi-tiered network for storage.

5. The system of claim 2, wherein the application server of the second tier of the multi-tiered network generates a lump sum payment quote that is instantaneously relayed to the first tier of the multi-tiered network for transmission to the user, and wherein the lump sum payment quote is simultaneously transmitted instantaneously to the database server of the third tier of the multi-tiered network for storage.

6. The system of claim 5, wherein the lump sum quote reflects a guaranteed payment offer.

7. The system of claim 3, wherein the application server of the second tier of the multi-tiered network generates a lump sum payment quote that is instantaneously relayed to the first tier of the multi-tiered network for transmission to the user, and wherein the lump sum payment quote is simultaneously transmitted instantaneously to the database server of the third tier of the multi-tiered network for storage.

8. The system of claim 7, wherein the lump sum quote reflects a life contingent payment offer.

9. The system of claim 6, wherein the application server executes and generates lump sum payment quote comprises a first numerical figure, wherein the first numerical figure is a minimum upfront lump sum payable to the recipient and a second numerical figure, and wherein the second numerical figures is a maximum upfront lump sum payable to the recipient.

10. The system of claim 8, wherein the application server executes and generates lump sum payment quote comprises a first numerical figure, wherein the first numerical figure is a minimum upfront lump sum payable to the recipient and a second numerical figure, and wherein the second numerical figures is a maximum upfront lump sum payable to the recipient.

11. The system of claim 6, wherein the lump sum payment quote is initially revealed and displayed to the user for a first period of time.

12. The system of claim 8, wherein the lump sum payment quote is initially revealed and displayed to the user for a first period of time.

13. The system of claim 10, wherein the user is prompted to enter a unique code generated by the system and transmitted to the user, for verification in order to retrieve the lump sum payment quote for a second period of time subsequent to the first period of time.

14. The system of claim 10, wherein the first period of time is within a range of 1 to 10 seconds.

15. The system of claim 1, wherein the first set of field parameters includes a first plurality of fields, wherein the first plurality of fields solicits a response to variously identify, the recipient's first name, the recipient's last name, an insurance company, wherein the insurance company identifies a structured settlement company providing monetary payments to the recipient, the recipient's age, gender or e-mail.

16. The system of claim 2, wherein the second set of field parameters includes a second plurality of fields, wherein the second plurality of fields solicits a response to variously identify, a payment type, wherein the payment type is a life contingent payment or a guaranteed payment, a payment start date, wherein the payment start date is the date that a structured settlement company starts or started providing monetary payments to the recipient, a payment end date,
wherein the payment start end date is the date that a structured settlement company will stop providing monetary payments to the recipient, a payment amount, a payment frequency, wherein the payment frequency identifies a period payment, including weekly, monthly, quarterly, semi-annual or annual period payments, a payment amount,
wherein the payment amount identifies the payment amount disbursed to the recipient within the period payment; and an annual increase percentage rate, wherein the annual increase percentage rate ranges from 1 to 10.

17. The system of claim 3, wherein the third set of field parameters includes a third plurality of fields, wherein the third plurality of fields solicits a response to variously identify the recipient's personal attributes, wherein the personal attributes relate to the recipient's height, weight, health profile and status, including smoking status, blood pressure, and driving record, including suspensions of driver license, driving under the influence, driving while intoxicated.

18. The system of claim 1, wherein the database server includes a source available cross platform, document oriented, database program.

19. The system of claim 2, wherein the data stored in the database server includes the lump sum quote.

20. The system of claim 3, wherein the data stored in the database server includes the lump sum quote.

21. The system of claim 1, wherein a cloud server is in communication with the first tier and the second tier, whereby the first set of data is transmitted to the second tier via the cloud server.

22. The system of claim 5, wherein a cloud server is in communication with the second tier and the first tier, whereby the lump sum payment quote generated by the application server of the second tier is instantaneously relayed to the first tier via the cloud server.

23. The system of claim 3, wherein data responsive to the third set of field parameters is auto-filled with data configured to provide the recipient with an optimum payment offer
